(19) United States
(12) Patent Application Publication
(10) Pub. No.: US 2005/0105708 A1
(43) Pub. Date: May 19, 2005

(54) Method of routing signals through communication networks

(75) Inventors: Farrokh Mohammadzadeh Kouchri, Boca Raton, FL (US); Bizhan Karimi-Cherkandi, Boca Raton, FL (US)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 10/959,099

(22) Filed: Oct. 7, 2004

Related U.S. Application Data
(60) Provisional application No. 60/513,639, filed on Oct. 23, 2003.

(51) Int. Cl. H04M 7/00; H04L 12/66

(52) U.S. Cl. 379/219; 370/352

(57) ABSTRACT

In a communication network, every subscriber has among all the calls he originates one or more call groups he frequently calls. To avoid repetitive call processing, the network allows for a more efficient call processing using the routing information of a previous call to the same subscriber. This allows a network element such as a switch to use existing routing information for the next same call instead of determining the routing information each time anew. The network and a method implemented therein identify the one or more call groups, store the routing information for these call groups, and use the stored routing information for the next same-call establishment.

### CROSS REFERENCE TO RELATED APPLICATIONS

The present application claims priority to provisional patent application Ser. No. 60/513,639 filed on Oct. 23, 2003, which is herein incorporated by reference.

### BACKGROUND OF THE INVENTION

The embodiments described herein generally relate to communications networks and communications methods within these networks. More particularly, the embodiments relate to an apparatus and a method for routing signals through a communications system.

One way of characterizing communication networks is to refer to the manner of how information is routed through the networks. The more traditional networks are circuit-switched networks such as time division multiplexing (TDM) networks. The TDM network establishes a physical path between two subscriber terminals that is dedicated to a single connection between the two terminals for the duration of the connection, e.g., a telephone call. More and more advancing are packet switched networks, such as Internet Protocol (IP) and Asynchronous Transfer Mode (ATM) networks. An ATM network, for example, routes small units of data, hereinafter referred to as packets, through the network based on the destination address contained within each packet. Each network point analyzes the packet to determine where to send it next. The packets in the same message may travel different routes towards its destination and may not arrive in the same order they were sent. At the destination, the packets in a message are collected and reassembled into the original message.

Circuit-switched and packet-switched networks include switches, for example, EWSD switch systems available from Siemens Corporation. Each switch directs the incoming data from any of multiple input ports to a specific output port that forwards the data toward its intended destination. For example, in a local area network (LAN), each switch determines from the physical device address in each incoming message frame the specific output port and internally channels the data to that specific output port. In a wide area network (WAN) such as the Internet, each switch determines from the IP address within each packet the specific output port to use for the next part of the packet's trip to the intended destination. In the Open Systems Interconnection (OSI) communications model, a switch performs the layer 2 or data link layer function.

A router or, in some cases, software in a computer, may be a part of a switch. A router determines the next network point the switch should forward, for example, a packet. The router is connected to at least two networks and decides which way to send each information packet based on its current understanding of the state of the networks it is connected to. A router may be located at any gateway, i.e., where one network meets another network. A router may create or maintain a database of the available routes and their conditions and use this information along with distance and cost algorithms to determine the best route for a given packet. Typically, a packet may travel through a number of network points with routers before arriving at its destination. In the OSI model, routing is a function of the network layer (layer 3). For example, a layer-3 switch is a switch that can perform routing functions.

### SUMMARY OF CERTAIN INVENTIVE ASPECTS

Regardless of the switching technology used within a network, a switch uses a good share of its performance for performing the routing task. For example, each time a subscriber or customer picks up the phone to make a call, the switch that hosts within the network the subscriber analyzes the dialed number (DN) to route the call to the most appropriate of its output ports. The analysis of the dialed number is time consuming and negatively affects the number of call attempts the switch can handle during a busy hour (BHCA: Busy-Hour Call Attempts). It is therefore an objective to provide a system that has an improved mechanism for routing the call.

Accordingly, one aspect involves a method of routing communication signals through a communication network. A first routing information is determined at a network element for a first communication originating from a first subscriber and directed to a second subscriber. The first communication is routed through the network element according to the first routing information. The first routing information is made available for a second communication from the first subscriber to the second subscriber.

Another aspect involves a communication network having a network element coupled to receive a first communication originating from a first subscriber and to forward the first communication to a second subscriber. The network element comprises a call processor configured to determine a first routing information for the first communication, to route the first communication through the network element according to the first routing information, and to make the first routing information available for a second communication from the first subscriber to the second subscriber.

A further aspect involves a method of routing communication signals through a communication network. Each communication of a first subscriber is logged, and the logged communications is evaluated after a predetermined period of time to determine frequent communications to a second subscriber and routing information for the frequent communications. The method determines if a new communication by the first subscriber is a frequent communication to the second subscriber, for which routing information is available. If it is a frequent call, the new communication is routed according to the available routing information.

Yet another aspect involves a communication network having a network element for routing communication signals. The network element is coupled to receive a first communication originating from a first subscriber and to forward the first communication to a second subscriber. The network element includes a call processor configured to log each communication of the first subscriber, to evaluate the logged communications after a predetermined period of time to determine frequent communications to the second subscriber and routing information for the frequent communications, to determine if a new communication by the first subscriber is a frequent communication to the second subscriber, for which routing information is available, and to route the new communication according to the available routing information.

The various embodiments described herein take into account that a subscriber usually has a group of phone numbers the subscriber frequently calls, such as the numbers of family members and friends. The switch analyzes and routes these frequent calls over and over with the same routing outcome. To reduce the time for routing these frequent calls, one embodiment described herein stores the routing information and uses the stored routing information for the next same-call establishment.

### BRIEF DESCRIPTION OF THE SEVERAL VIEWS OF THE DRAWINGS

These and other aspects, advantages and novel features of the embodiments described herein will become apparent upon reading the following detailed description and upon reference to the accompanying drawings. In the drawings, same elements have the same reference numerals.

FIG. 1 shows a schematic illustration of one embodiment of a communication network,

FIG. 2a shows one embodiment of a table with logged calls,

FIG. 2b shows one embodiment of a table listing details of frequently called numbers,

FIG. 3 is a flow chart illustrating a procedure implementing a method of routing signals in the communication network of FIG. 1,

FIG. 4 is a flow chart illustrating a procedure implementing a method of answering a call,

FIG. 5 is a flow chart illustrating a procedure implementing a method of normal call clearing,

FIG. 6 is a flow chart illustrating a procedure implementing a method of abnormal call clearing,

FIG. 7 is a flow chart illustrating a procedure implementing a method of evaluating calls during an off peak time,

FIG. 8 is a first swim lane diagram illustrating the steps of obtaining and using pre-route information for routing signals between subscriber A and subscriber B according to a first embodiment, and

FIG. 9 is a second swim lane diagram illustrating the steps of obtaining and using pre-route information for routing signals between subscriber A and subscriber B according to a second embodiment.

### DETAILED DESCRIPTION OF CERTAIN INVENTIVE EMBODIMENTS

The following description of certain inventive embodiments is directed to a system and method for routing signals within a communication network. The description is based on a scenario where a local subscriber or customer communicates via a communication network with a remote subscriber or customer. For example, the local subscriber may dial a phone number assigned to the remote subscriber to initiate and conduct a telephone call with the remote subscriber. The communication between the subscribers is hereinafter generally referred to as a call. However, those of ordinary skill in the art will appreciate that the embodiments are not limited to voice communications and are, in fact, equally suitable for data communications in general such as involving telefax, audio, video, data, video phone and multimedia services.

It is contemplated that the communication network and method may be based on one of several communications technologies such as circuit-switched ISDN, packet-switched IP or ATM networks, or voice-enabled data Next-Generation Networks (NGN) that support both existing voice services and evolving applications such as integrated access, Virtual Private Network (VPN), Internet call waiting, click to dial, unified messaging, enhanced roaming, or the like. Furthermore, the communication network may be based on a technology that converges, for example, a TDM network and a packet network. Without limiting the embodiments to a certain network technology, the description of certain inventive embodiments is hereinafter based on a packet-switched network.

The communication network and method provide for an improved performance of network elements such as switches because the time required for processing calls is reduced for certain calls. Every subscriber has among all the calls he originates one or more call groups he frequently calls. Hence, a switch needs to process the calls to a call group over and over with essentially the same routing result. To avoid such repetitive call processing, the system and method described herein allow for a more efficient call processing using the routing information of a previous call to the same subscriber. This allows the switch to use existing routing information for the next same call instead of determining the routing information each time anew. In one embodiment, the network and method identify the one or more call groups, store the routing information for these call groups, and use the stored routing information for the next same-call establishment.

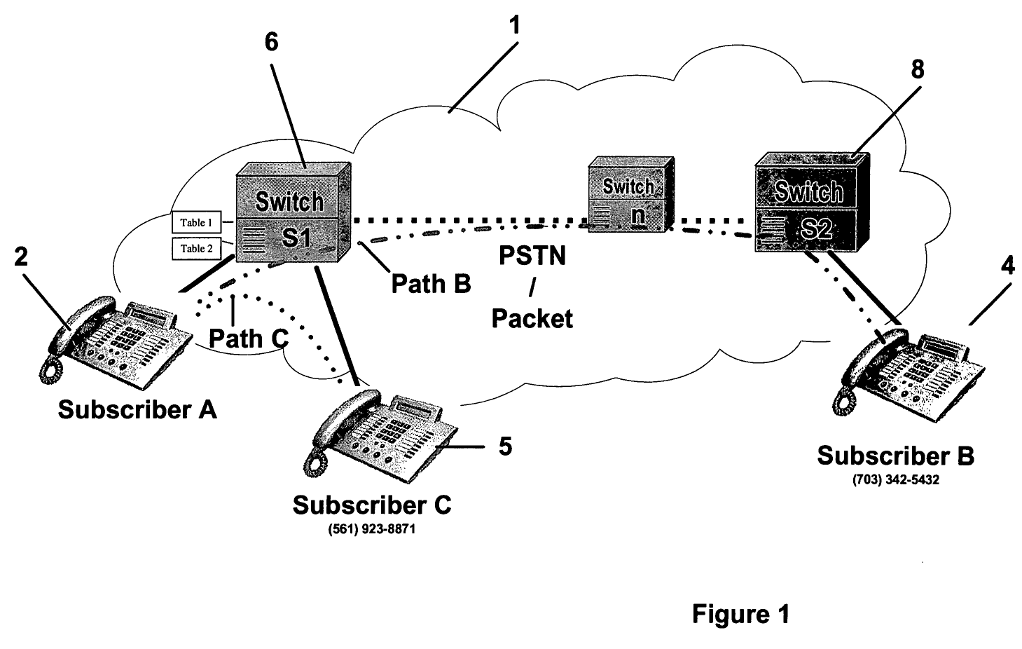

FIG. 1 shows a schematic illustration of one embodiment of a communication network 1. The network 1 includes network elements, for example, switches 6, 8 and subscriber terminals 2, 4, 5. In the illustrated embodiment, the terminal 2 is located at the premises of a subscriber A and coupled to the switch 6, the terminal 4 is located at the premises of a subscriber B and coupled to the switch 8, and the terminal 5 is located at the premise of a subscriber C and coupled to the switch 6. Information containers or databases (Table 1, Table 2) are in one embodiment available to the switch 6, as described below.

The databases may be implemented by means of a storage device within the switch 6 and are shown in FIG. 1 for illustrative purposes next to the switch 6, but it is contemplated that the databases may be maintained at other locations. A dotted line between the switches 6, 8 indicates that the network 1 may comprise additional switches and/or other network elements, such as gateways, to enable a communication between the subscribers A, B. The terminals 2, 4, 5 may be directly coupled to the switches 6, 8, as shown in FIG. 1. However, it is contemplated that the terminals 2, 4, 5 may be coupled to the switches 6, 8 via other network elements, such as class 4 switches or transport switches for ATM. The terminals 2, 4, 5 may be conventional telephones, wireless phones, computers, modems, fax machines, video phones, multimedia devices, or other voice and/or data communication devices.

In one embodiment, the switches 6, 8 are based on conventional switching technology, but modified to implement the inventive features described herein. A conventional switching technology is known by those of ordinary skill in the art. Briefly, each switch 6, 8 has a plurality of input ports coupled to incoming links and a plurality of output ports coupled to outgoing links. Incoming signals, for example, packets, are in one embodiment first stored in input buffers to give the processor enough time to process the signals. For routing purposes, the processing includes obtaining and reading the packet's destination address. The processor fetches the packets from the input buffers, analyzes the destination addresses, and forwards the packets to the appropriate output buffers. It is contemplated that the processing of the packets includes functions that are typically implemented in software.

In one embodiment, the tasks of a switch can be divided in three areas: a routing fabric, a switching fabric and a feature fabric. The following description of one embodiment of a routing method focuses on the routing fabric aspects of a switch. Further, with reference to the above scenario of two communicating subscribers, the following description of one embodiment of a routing method focuses on the switch 6 that hosts the subscriber A that initiates, for example, a call to the subscriber B. It is contemplated that the same method provides for the routing of a call from the subscriber B to the subscriber A. Further, it is contemplated that the routing method may be implemented for each subscriber in each switch within the network 1.

To determine and analyze a calling pattern of the subscriber A, it is advantageous to distinguish frequently dialed numbers, i.e., calls to his one or more calling groups, from infrequently, or only once, dialed numbers. For example, all calls the subscriber A makes during a set period of time are tracked and collected in a database. The set period of time may be a day, a week or a month, or any other suitable period of time. In one embodiment, the set period of time may be dependent on the switch 6, 8. In praxis, the switch 6, 8 has off-peak times where the volume of calls is low, for example, during night time. In that embodiment, the set period of time may be the time between two off-peak times.

When the subscriber A calls the subscriber B, the switch 6 always routes the call the same way, for example, using a path B shown in FIG. 1 as a broken line. The switch 6 hosts in the illustrated embodiment also the subscriber C. When the subscriber A calls the subscriber C, a path C is used for this call. FIG. 1 shows the path C as a dashed line. The switch 6 uses the path C for the same call at a later time. Hence, the paths B and C represent a set of routing information used to channel calls from the subscriber A to the subscribers B or C.

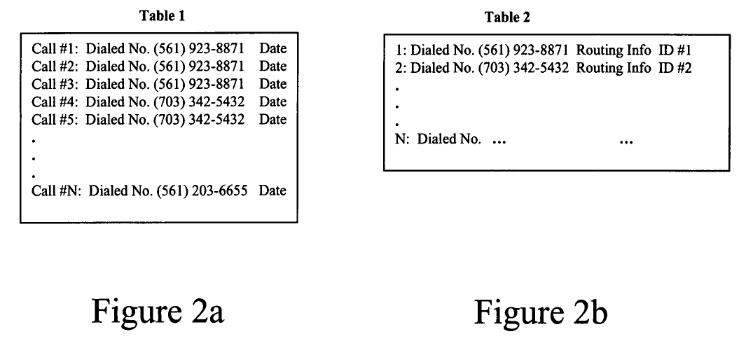

FIG. 2a shows one embodiment of a database implemented as a table, Table 1, with the subscriber A's logged calls. In the illustrated embodiment, Table 1 lists for each call subscriber A makes the dialed number and date. If the subscriber B answers a call, this call is marked in Table 1 as successful, i.e., connectable. If the call fails, e.g., because subscriber B does not answer or because of an invalid number, the call is marked as unsuccessful and disregarded from further evaluation or deleted from Table 1. At the end of the set period of time, the logged calls are evaluated to determine if the subscriber A called certain numbers frequently, for example, more than once or twice. If the table includes frequently dialed numbers, a representative call of each group of frequently dialed numbers is identified. The data relating to the representative call is assigned a frequent call identification number (ID #) and transferred to another table, Table 2. FIG. 2b shows one embodiment of database implemented also as a table (Table 2) listing details of the representative calls of the frequently called numbers.

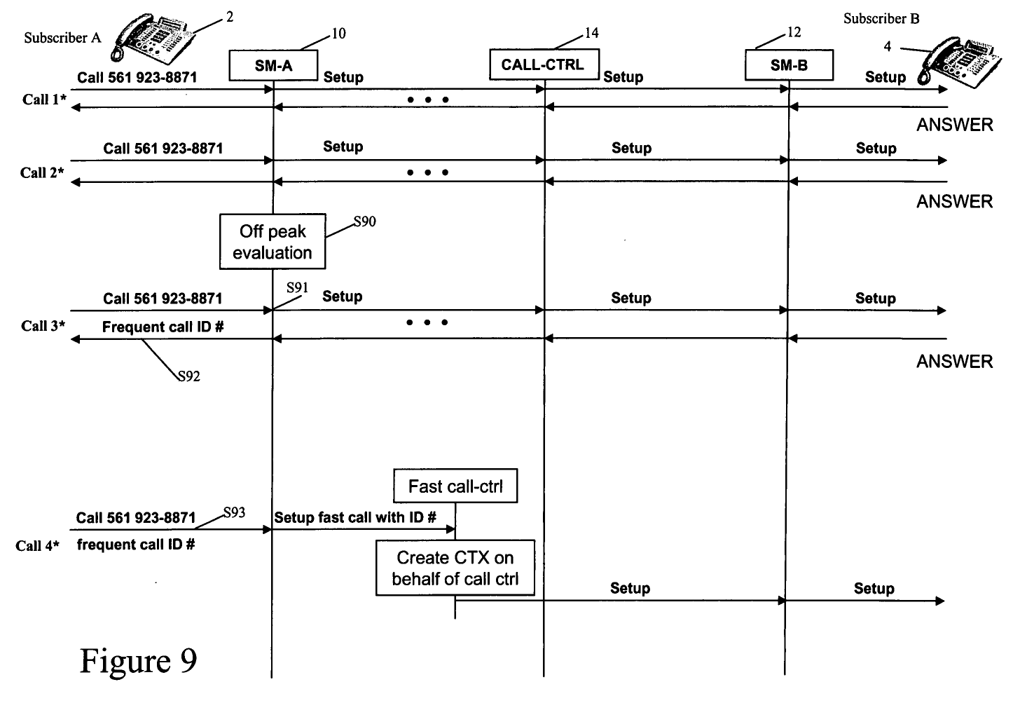

It is contemplated that the tables of FIGS. 2a, 2b are created for each subscriber within the network 1. The determination and analysis of a subscriber's calling pattern may be performed at the switch 6, 8, as described below in more detail. In the alternative, the determination and analysis of a subscriber's calling pattern may be performed with support from equipment at the subscriber's location, for example, by means of an intelligent customer premises equipment (CPE), as described below in more detail with reference to FIG. 9. One example of an intelligent CPE is a multimedia terminal adaptor available from Siemens Corporation.

Further, it is contemplated that the databases in form of the tables may be made available within the network 1, for example, in the switch 6 or an intelligent CPE, by means of a variety of storage media, such as diskettes, hard disks, memory storage devices or collection of memory storage devices such as read-only memory (ROM) or random access memory (RAM). In addition, it is contemplated that the tables illustrate only one advantageous implementation for supporting the determination and analysis of a subscriber's calling pattern. Alternatives to creating the tables include maintaining all calls in a list and marking the frequent calls, or using relational databases such as SQL or none relational databases.

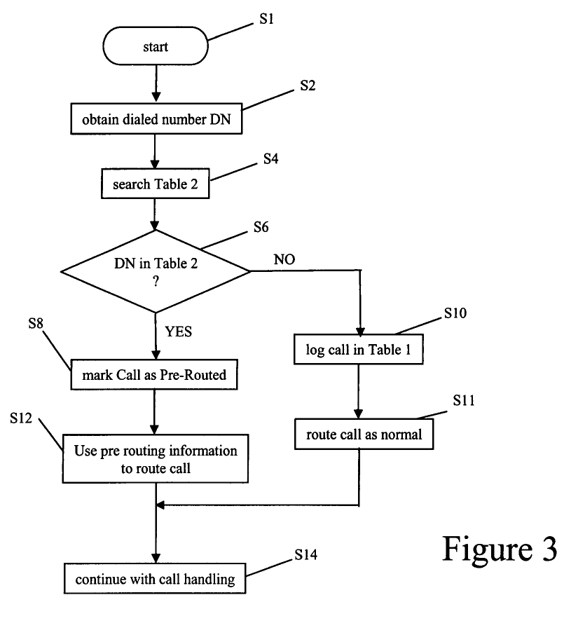

FIG. 3 is a flow chart illustrating a procedure implementing a method of routing signals in the communication network of FIG. 1. The procedure starts at a step S1. At this time, the tables (Table 1, Table 2) shown in FIGS. 2a, 2b are available, and the subscriber A dials a number to communicate with the subscriber B.

Proceeding to a step S2, the procedure obtains the number the subscriber A dialed during call establishment. In one embodiment, the switch 6 analyzes the incoming call request to identify the dialed number (DN).

Proceeding to a step S4, the procedure accesses and searches Table 2. As described above, a dialed number available in Table 2 means that the dialed number is one of subscriber A's frequently dialed numbers and routing information is already available.

Proceeding to a step S6, the procedure determines if the dialed number DN is available in Table 2. If the dialed number is available in Table 2, the procedure proceeds along the YES branch to a step S8. In step S8, the procedure marks the call as a pre-routed call because routing information is already available for this call.

Proceeding to a step S12, the procedure uses the available routing information to route the call. As a consequence, the switch 6 does not have to use its resources to determine routing information for this call since that call has been routed before.

If the procedure determines in step S6 that the dialed number is not available in Table 2, the procedure proceeds along the NO branch to a step S1. In step S10, the procedure enters the dialed number in Table 1, i.e., the table where all calls the subscriber A makes are logged.

In a step S11, as no previously determined routing information is available in Table 2, the procedure routes the call using the normal routing fabric of the switch 6. Regardless if the call is pre-routed (steps S8, S12) or not (steps S10, S11), the procedure continues in a step S14 with the call handling. For example, the procedure may invoke in step S14 other switch tasks such as feature fabric. Should the routing result be negative, then the entry from Table 2 is in one embodiment deleted.

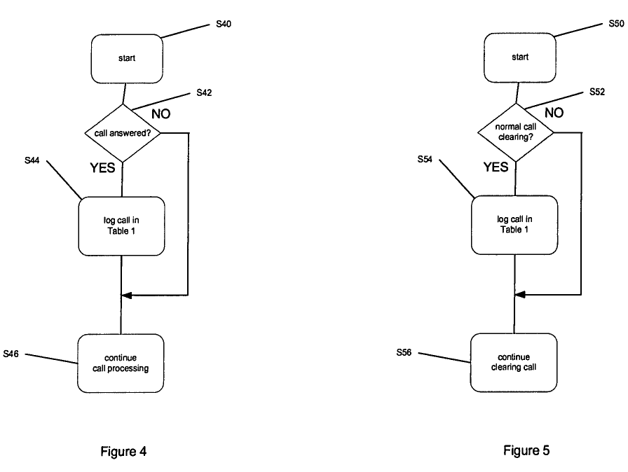

FIG. 4 is a flow chart illustrating a procedure implementing a method of answering a call to describe one embodiment for creating Table 1. The procedure starts at a step S40 and a call from the subscriber A is directed towards the subscriber B.

Proceeding to a step S42, the procedure determines if the subscriber B answers the call. If the call is answered, i.e., is connectable, the procedure proceeds along the YES branch to a step S44. In step S44, the procedure logs the call in Table 1 as a connectable call and proceeds to a step S46.

If the call is not answered in step S42, the procedure proceeds along the NO branch to step S46. That is, the call is not logged in Table 1. In step S46, the procedure continues with processing the call depending on the outcome of the determination in step S42. If the subscriber B answers, the call processing establishes a connection between the subscribers A and B so that they can communicate. If the subscriber B does not answer and the subscriber A hangs up for failure to receive an answer from the subscriber B, the call processing sets the system back in its idle state.

FIG. 5 is a flow chart illustrating a procedure implementing a method of normal call clearing to describe another embodiment for creating Table 1. The procedure starts at a step S50 and, in one embodiment, the subscribers A, B are having a telephone conversation.

Proceeding to a step S52, the procedure determines if a normal call clearing occurs. A normal call clearing occurs, for example, when the subscribers A and B hang up at the end of their conversation and the connection is disconnected. A normal call clearing occurs also if the subscriber A hangs up because the subscriber B does not answer. However, this may still be a potential frequent call.

If a normal call clearing occurs, the procedure proceeds along the YES branch to a step S54. In step S54, the procedure logs the call in Table 1 as a successful and connectable call and proceeds to a step S56. That is, the call is logged because it may be a potential frequent call regardless if the call is cleared after both subscribers A, B hang up or the subscriber A hangs up because the subscriber B does not answer.

If a normal call clearing does not occur in step S52, for example, because of an invalid number or the network is congested, the procedure proceeds along the NO branch to step S56. That is, the call is not logged in Table 1. In step S56, the procedure continues with clearing the call.

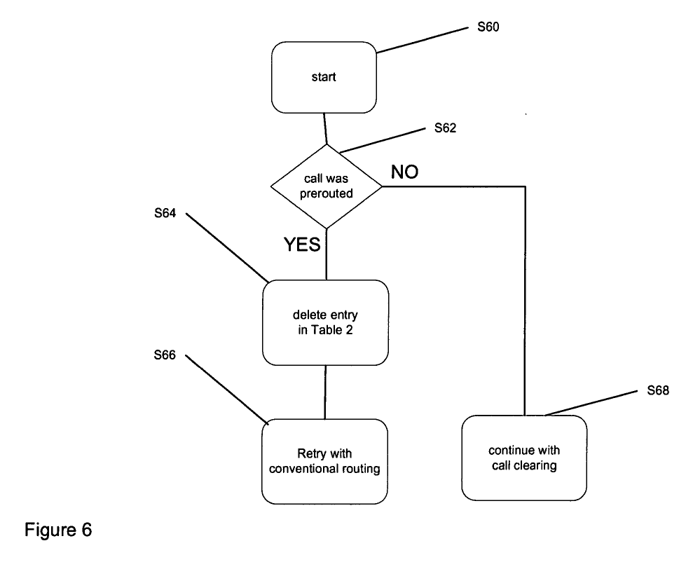

FIG. 6 is a flow chart illustrating a procedure implementing a method of abnormal call clearing. The procedure starts at a step S60.

Proceeding to a step S62, the procedure determines if the call is pre-routed. If the call is pre-routed, the procedure proceeds along the YES branch to a step S64.

In step S64, the procedure deletes from Table 2 the entry that relates to the present call. That is, since an abnormal call clearing occurs even though the call is pre-routed, the procedure deletes the related data from Table 2.

Proceeding to a step S66, the procedure retries to establish a call using a conventional routing procedure without using pre-routing information for this call.

If the procedure determines in step S62 that the call is not pre-routed, the procedure proceeds along the NO branch to a step S68. In step S68, the procedure continues with clearing the call.

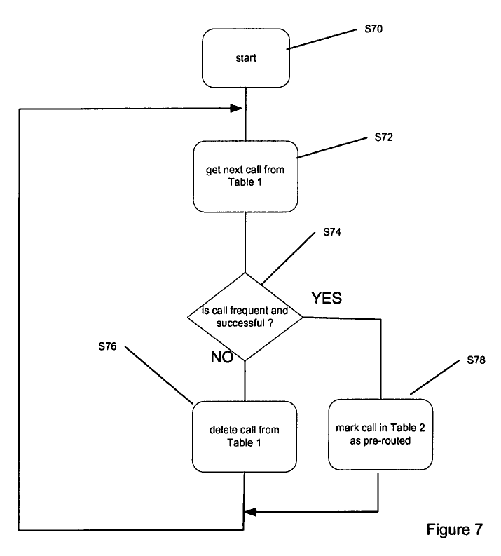

FIG. 7 is a flow chart illustrating a procedure implementing a method of evaluating calls during an off peak time. The procedure starts at a step S70 and Table 1 is available.

Proceeding to a step S72, the procedure accesses Table 1 and gets the information relating to the next logged call from Table 1 and proceeds to a step S74.

In step S74, the procedure determines if the call is a frequent and successful call. If the call is frequent and successful, the procedure proceeds along the YES branch to a step S78. In step S78, the procedure transfers the call to Table 2 and marks it as pre-routed to indicate that pre-routing information is available for this call.

If the call is not a frequent call, the procedure proceeds along the NO branch to a step S76. In step S76, the procedure deletes this call from Table 1. In both cases, the procedure returns to step S72, gets the next call from Table 1 and repeats the appropriate steps S74-S78.

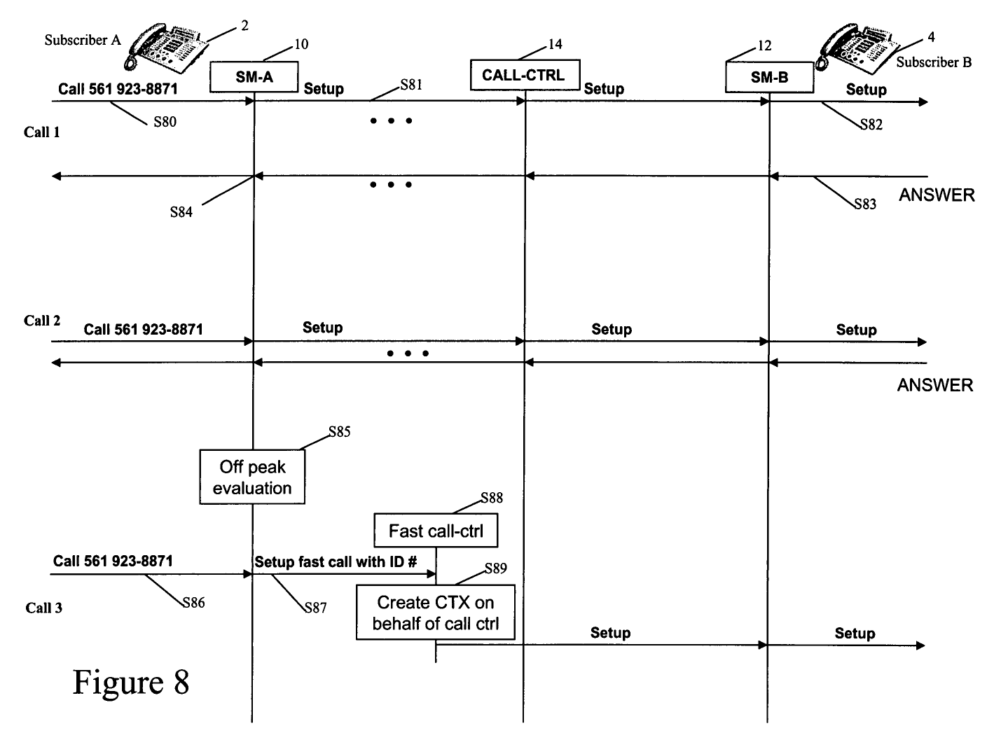

FIG. 8 is a swim lane diagram illustrating the steps of obtaining and using pre-routing information for routing signals between subscriber A and subscriber B, wherein the switch 6 determines and stores the calling pattern of subscriber A. Swim lane diagrams may show the relationship and typical messaging sequencing among “actors” or “components”. The components of the swim lane diagram include an originating end equipment at (e.g., the terminal 2) or near the location of the subscriber A and a corresponding terminating end equipment at (e.g., the terminal 4) or near the location of the subscriber B for originating and terminating an exemplary call sequence. Further included in the swim lane diagram is a signaling manager 10 assigned to subscriber A (SM-A), a call controller 14 (CALL-CTRL) and a signaling manager 12 assigned to subscriber B (SM-B). Note that the separation of the signaling managers 10, 12 from the call controller 14 is an exemplary illustration. In other switches the signaling managers and the call controller may be implemented in a different way. The signaling manager can be any type of signaling manger, for example, as used in analog telephony (POT), ISDN, H323 systems.

Referring to FIG. 8, a series of exemplary call setup sequences (and associated sequenced messages among the components) is shown for calls Call 1, Call 2 and Call 3 where, generally, a call is originated from an idle state to a talk state and then upon termination of the exemplary call, back to the idle state (not shown in FIG. 8). To illustrate one of the exemplary call setup sequences in more detail, in a step S80 of Call 1, the signaling manager 10 recognizes that the subscriber A dialed at the terminal 2 the number assigned to the subscriber B.

In a step S81, the signaling manager 10 initiates a communication with the call processor 14 within the switch 6 and requests a call setup. The call processor 14 processes the call setup request and performs a variety of tasks, such as authentication handling, routing processing and creation of a context (CTX) data structure.

In a step S82, the call processor 14 initiates a communication with the signaling manager 12 assigned to subscriber B. After performing its assigned tasks, the call processor 14 forwards the call setup request to the signaling manager 12. The signaling manager 12 signals to the terminal 4 at the subscriber B premises that a call is incoming.

In a step S83, the subscriber B answers the call and an address complete message indicating a successful call is returned through the network 1 to the subscriber A. The network element that maintains Table 1, e.g., the switch 6, adds in a step 84 this call to Table 1 as a successful call. If the subscriber B does not answer, the call may be marked as unsuccessful and subsequently disregarded and removed from Table 1.

In the illustrated embodiment, note that in Call 2 the same process takes place as in Call 1 including logging Call 2 in Table 1. In a step S85, the procedure performs an “off-peak evaluation” during an off-peak time of the switch. This evaluation includes in one embodiment counting how often the same number is entered in Table 1, i.e., evaluating the dialed number for its frequency. If the call is a frequent call, the evaluation process creates a frequent call identification number (ID #) for this call and obtains pre-routing information for this number including pre-authenticate sub routine, routing, pre-created context (CTX) data eventually without a CTX name. The frequently dialed numbers together with the respective frequent call ID # and the routing information are transferred to Table 2.

In a step S86, when the subscriber A launches Call 3 to the same number, the signaling manager 10 searches Table 2. If the dialed number of Call 3 is in Table 2, the signaling manager 10 marks Call 3 in a step S87 as pre-routed, for example, by means of the frequent call ID # to enable a fast call setup. Additional information linked with the frequent call ID # includes billing, partner address and context CTX information. Contexts or Call Control Blocks CCBs or Transaction Control Blocks TCBs are usually so called transient data structures that last at least during a call and contain all information required for the call, such as subscriber specific information, restrictions, capabilities, name, number, presentation, default features, active features, dialed number, destination, billing information, media description, media control information, events occurred during the call, reroute information, B subscriber information and much more.

In a step S88, a fast-call controller receives and processes a setup request with the frequent call ID #. The fast-call controller obtains the routing information, semi-permanent data and invariant data for this specific call by means of Table 2 and adds it in a step S89 to a dynamic data structure required for this call in a call control function and sets the call control state accordingly on behalf of the call controller 14. The dynamic data structure (CTX) includes further data such as CTX name or ID and media description and information. That is, the processing of the frequent call ID # by the fast-call controller allows to by-pass the determination of the routing information and other invariant and semi-permanent data in the call processor 14. The subsequent steps in the setup sequence are as described above.

Similar to FIG. 8, FIG. 9 is a swim lane diagram illustrating a series of four exemplary call setup sequences for calls Call 1*, Call 2*, Call 3* and Call 4* according to another embodiment. In the embodiment of FIG. 9, an intelligent equipment at the subscriber A's premises supports identification of the subscriber A's calling pattern. The call setup sequences for calls Call 1* and Call 2* and the off-peak evaluation in a step S90 are as described with reference to FIG. 8 for calls Call 1 and Call 2 and the off-peak evaluation in the step S85.

In a step S91 of the setup sequence for Call 3*, the signaling manager 10 adds the frequent call ID # to the call setup request message. Without using the fast call setup process described above, the call is routed to subscriber B. With the subscriber B's answer, the frequent call ID # is returned to the signaling manager 10.

In a step S92, the intelligent equipment at the subscriber A's premises receives and stores the frequent call ID #. The frequent call ID # is associated with the dialed number and routing information for Call 3*.

In a step S93, the intelligent equipment uses the frequent call ID # to setup Call 4*. With the frequent call ID # used for Call 4*, the signaling manager 10 recognizes Call 4* as pre-routed and enables a fast call setup. The subsequent steps for establishing Call 4* are in one embodiment as described with reference to steps S88 and S89 of FIG. 8.

As to the handling of the routing information several options may be implemented. Table 2 with the routing information may be stored within the switch 6, for example, in a cache assigned to the first incoming call handler of the switch 6. This is described with reference to FIG. 8. In an alternative embodiment, the frequent call ID # is only an index, but Table 2 with the routing information is stored within the switch 6. In another alternative embodiment, the intelligent equipment at the subscriber's premises stores Table 2 and the complete routing information. During the process of establishing a frequent call, the routing information for this frequent call is transmitted back to the call processor of the switch 6. FIG. 9 illustrates exemplary implementations of the two alternative embodiments.

Under certain traffic conditions, the switch 6 may encounter problems in routing the call using the pre-route information. In such a case, the switch 6 attempts to route the call without the pre-route information in a conventional way.

The steps of the swim lane diagrams and flow charts described herein may be implemented on computer program code in combination with appropriate hardware components. This computer program code may be stored on storage media such as a diskette, hard disk, CD-ROM, DVD-ROM or tape, as well as memory storage devices or collection of memory storage devices such as read-only memory (ROM) or random access memory (RAM). Additionally, the computer program code may be transferred to a workstation over the Internet or some other type of network.

It is apparent that there has been disclosed an apparatus and method for extinguishing a fire that fully satisfies the objects, means, and advantages set forth hereinbefore. While specific embodiments of the apparatus and method have been described, it is evident that many alternatives, modifications, and variations will be apparent to those skilled in the art in light of the foregoing description.

1. A method of routing communication signals through a communication network, comprising:
determining a first routing information at a network element for a first communication originating from a first subscriber and directed to a second subscriber;
routing the first communication through the network element according to the first routing information; and
making the first routing information available for a second communication from the first subscriber to the second subscriber.

2. The method of claim 1, wherein making the first routing information available includes storing the first routing information within the network element.

3. The method of claim 1, wherein making the first routing information available includes storing the first routing information within equipment at premises of the first subscriber.

4. The method of claim 1, wherein making the first routing information available includes storing a first index within equipment at premises of the first subscriber, wherein the first index points the first routing information stored within network element.

5. The method of claim 1, further comprising marking the second communication as pre-routed.

6. The method of claim 1, further comprising routing the second communication through the network element according to the first routing information.

7. A communication network, comprising a network element coupled to receive a first communication originating from a first subscriber and to forward the first communication to a second subscriber, wherein the network element comprises a call processor configured to determine a first routing information for the first communication, to route the first communication through the network element according to the first routing information, and to make the first routing information available for a second communication from the first subscriber to the second subscriber.

8. The network of claim 7, further comprising a storage device to store the first routing information.

9. A method of routing communication signals through a communication network, comprising:
logging each communication of a first subscriber;
evaluating the logged communications after a predetermined period of time to determine frequent communications to a second subscriber and routing information for the frequent communications;
determining if a new communication by the first subscriber is a frequent communication to the second subscriber, for which routing information is available; and
routing the new communication according to the available routing information if the new communication is a frequent communication.

10. The method of claim 9, wherein each communication of the first subscriber is logged in a first database.

11. The method of claim 10, further comprising transferring data regarding each frequent call to a second database.

12. The method of claim 11, further comprising searching the second database to determine if the new communication by the first subscriber is a frequent communication.

13. The method of claim 12, further comprising identifying the new communication as pre-routed if the new communication is a frequent call.

14. The method of claim 9, further comprising creating an identification number for a frequent call.

15. The method of claim 14, further comprising transmitting the identification number to equipment at premises of the first subscriber, and maintaining the available routing information for frequent calls at a network element.

16. The method of claim 15, further comprising identifying the new communication through the identification number at the premises of the first subscriber, transmitting the new communication together with the identification number to the network element, and obtaining the available routing information associated with identification number at the network element.

17. The method of claim 9, further comprising maintaining the available routing information at a network element.

18. The method of claim 9, further comprising transmitting the available routing information from a network element to equipment at premises of the first subscriber.

19. The method of claim 18, further comprising transmitting the new communication together with available routing information from the first subscriber's premises to the network element.

20. A communication network comprising a network element for routing communication signals, the network element coupled to receive a first communication originating from a first subscriber and to forward the first communication to a second subscriber, wherein the network element comprises a call processor configured to log each communication of the first subscriber, to evaluate the logged communications after a predetermined period of time to determine frequent communications to the second subscriber and routing information for the frequent communications, to determine if a new communication by the first subscriber is a frequent communication to the second subscriber, for which routing information is available, and to route the new communication according to the available routing information.
